(19) United States
(12) Patent Application Publication
(10) Pub. No.: US 2007/0076137 A1
(43) Pub. Date: Apr. 5, 2007

(54) PORTABLE ELECTRONIC DEVICE WITH POWER SAVING FUNCTION

(75) Inventor: TSUNG-WEI CHIANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,515

(22) Filed: Aug. 16, 2006

(30) Foreign Application Priority Data
Aug. 26, 2005 (CN) 200510036898.9

(51) Int. Cl. G02F 1/1335

(52) U.S. Cl. 349/57

(57) ABSTRACT

A portable electronic device (100) includes a display assembly (21) including a liquid crystal module (23) configured for showing information, a cover (24) covering the liquid crystal module and receiving and concentrating external light, and a reflector (26) receiving light transmitted through the cover and directing the light to the liquid crystal module.

### FIELD OF THE INVENTION

The present invention generally relates to portable electronic devices such as mobile phones, personal digital assistants, palm-top computers and so on, and more particularly to a portable electronic device with power saving function.

### DESCRIPTION OF RELATED ART

Mobile phones are widely used throughout the world as, among other advantageous benefits as compared to conventional land-line telephones, mobile phones are slim, multifunctional, inexpensive, portable, and convenient while still enabling the user to enjoy high communication quality.

In recent years, large high-brightness color displays with white light emitting diode (LED) backlights have becomes a basic feature of most mobile phones, and various special features such as a digital cameras, on-line gaming, a video recording functions etc. have been added to mobile phones. Accordingly, use of large color displays and various special features consume large amounts of power thus reducing the service time between charges.

What is needed, therefore, is an improved portable electronic device with power saving function so as to increase the service time per full charge.

### SUMMARY OF INVENTION

In one aspect, a portable electronic device includes a display assembly including a liquid crystal module configured for showing information, a cover covering the liquid crystal module and receiving and concentrating external light, and a reflector receiving light transmitted through the cover and directing the light to the liquid crystal module.

Other advantages and novel features will become more apparent from the following detailed description when taken in conjunction with the accompanying drawings.

### BRIEF DESCRIPTION OF DRAWINGS

Many aspects of the present portable electronic device with power saving function can be better understood with reference to the following drawings. The components in the drawings are not necessarily drawn to scale, the emphasis instead being placed upon clearly illustrating the principles of the portable electronic device. Moreover, in the drawings, like reference numerals designate corresponding parts throughout the several views.

FIG. 1 is a schematic, disassembled, perspective view of a portable electronic device; and

FIG. 2 is an assembled, cross-sectional view of FIG. 1.

### DETAILED DESCRIPTION

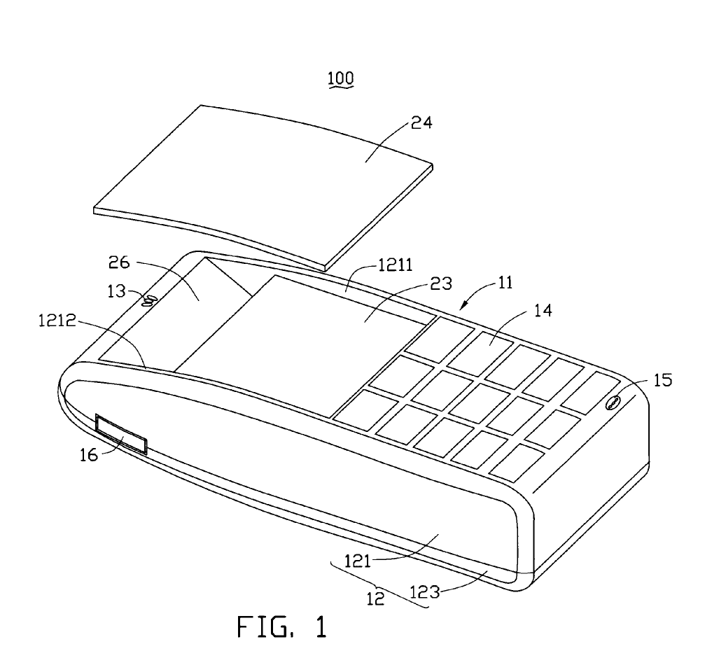

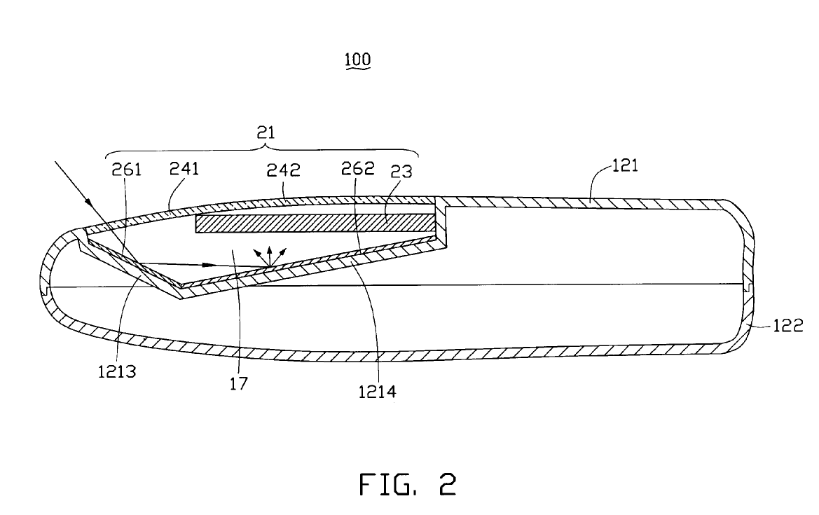

A portable electronic device 100, which is shown in FIGS. 1 and 2 to be a wireless communication device such as a mobile phone, includes a main body 11 and a display assembly 21 disposed on the main body 11. The display assembly 21 includes a liquid crystal module (LCM) 23, a cover 24 and a reflector 26.

The main body 11 has a housing 12 and a substrate (not shown), such as a printed circuit board included with multiple electronic components, seated in the housing 12. The housing 12 includes a front housing portion 121 and a rear housing portion 123. The front housing portion 121 includes an earpiece 13 for emitting sound information, a keypad 14 for entering or accessing information, and a microphone 15 for receiving sound input. The rear housing portion 123 houses a battery for providing power to the portable electronic device 100 and an antenna included therein for receiving and emitting signals thus enabling voice and data communication between the portable electronic device 100 and a remote device, such as another radiotelephone, a base station, or the like. A switch assembly 16 for executing functions of the electronic device 100, such as menu scrolling and earpiece volume adjustment, is housed on a side of the housing 12 wherein the front and rear housing portions 121 and 123 join.

The front housing portion 121 includes two sidewalls 1211, 1212 on opposite sides of the front housing 121 to each other, a front inclined plane 1213 between the sidewalls 1211, 1212 and a rear inclined plane 1214 connecting to and subtending at an angle to the front inclined plane 1211. The two sidewalls 1211, 1212, the front inclined plane 1213 and the rear inclined plane 1214 co-operatively form a substantially V-shaped cavity 17. The cavity 17 is adjacent to the keypad 14 and has an opening communicating with the outside.

The display assembly 21 is configured (i.e., structured and arranged) for showing information to a user. The LCM 23 of the display assembly 21 is received in the cavity 17 of the front housing portion 121 and electrically connects with the substrate of the main body 11. The LCM 23 extends parallel to the keypad 14 and covers the rear inclined plane 1214. The LCM 23 includes a light guide plate (not shown) to receive backlight and spread the light in a manner such that it has a more uniform light intensity on exiting the light guide plate.

The cover 24 of the display assembly 21 is mounted to the front housing portion 121 and closes the opening of the cavity 17, in order to protect the LCM 23 from becoming cracked or broken and prevent the LCM 23 from external contamination or pollution. The cover 24 is made of transparent material such as glass or plastic, and includes a front portion 241 and a rear portion 242. The front portion 241 of the cover 24 corresponds to the front inclined plane 1213 of the front housing portion 121, and concentrates and directs external light, such as sunshine, lamp light and the like, to the front inclined plane 1213. The front portion 241 of the cover 24 can be a convex lens, Fresnel lens or other lens which can converge light. The rear portion 242 corresponds to the LCM 23 for a user viewing information therethrough.

The reflector 26 should be of high reflectivity, and include a front reflecting layer 261 and a rear reflecting layer 262. The front reflecting layer 261 should be fixed to the front inclined plane 1213. The front reflecting layer 261 is configured (i.e., structured and arranged) for receiving light transmitted from the front portion 241 of the cover 24 and reflecting the light. The rear reflecting layer 262 is secured to the rear inclined plane 1214. The rear reflecting layer 262 is configured (i.e., structured and arranged) for receiving light reflected by the first reflecting layer 261, and reflecting and scattering the light to the LCM 23 in order to provide an additional back light source. The front reflecting layer 261 and the rear reflecting layer 262 can connect to each other to be a one-piece reflector as shown in FIG. 2, or can be separated from each other.

In use, external light passes through the front portion 241 of the cover 24, and is converged and guided to reach the front reflecting layer 261. Then the external light is reflected and directed to the rear reflecting layer 262 by the front reflecting layer 261. The external light is scattered and directed to the LCM 23 by the rear reflecting layer 262. Thus, the external light is used as an additional back light source of the LCM 23.

When a portable electronic device 100 with power saving function is used in an environment having substantial external light, the portable electronic device 100 can be manually switched to a power saving mode by the user, in order to turn off an internal back light source, such as LEDs (light emitting diodes), included therein and use external light as back light source. When the portable electronic device 100 is used in an environment lacking external light, the portable electronic device 100 can be reset to a normal mode that uses the internal back light source.

It is to be understood that, a light detector (not shown), such as a photosensitive resistor, can be included in the portable electronic device 100 to detect intensity of the external light and transmit a signal representing the intensity of the external light to a micro-programmed control unit (MCU) in the portable electronic device 100. The MCU of the portable electronic device 100 can automatically change the portable electronic device between the power saving mode and the normal mode depending on the light intensity signal it receives from the light detector, which can facilitate the operation of the portable electronic device 100.

In addition, if the brightness of the internal light source of the portable electronic device 100 can be manually adjusted by the user or automatically adjusted by the MCU, the portable electronic device can use both the external light and the internal light as back light source at a same time. That is, when the external light is insufficient by itself to act as a back light source, the internal back light source can be adjusted to a suitable brightness to supplement the external light thus providing a substantial back light source together with the external light.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A portable electronic device, comprising:
a display assembly comprising:
a liquid crystal module, the liquid crystal module configured for showing information;
a cover, the cover covering the liquid crystal module, and configured for receiving and concentrating external light; and
a reflector configured for receiving light transmitted through the cover and directing the light to the liquid crystal module.

2. The portable electronic device as claimed in claim 1, wherein the cover comprises a rear portion, the rear portion corresponds to the liquid crystal module to show information.

3. The portable electronic device as claimed in claim 2, wherein the cover is made of transparent material.

4. The portable electronic device as claimed in claim 2, wherein the cover further comprises a front portion which is chosen from the group consisting of a convex lens and a Fresnel lens.

5. The portable electronic device as claimed in claim 4, wherein the reflector comprises a front reflecting layer receiving light transmitted through the front portion of the cover, and a rear reflecting layer receiving light reflected by the front reflecting layer and reflecting and scattering the light to the liquid crystal module.

6. The portable electronic device as claimed in claim 5 further comprising a housing comprising a front housing portion to incorporate the display assembly and a rear housing portion cooperating with the front housing portion.

7. The portable electronic device as claimed in claim 6, wherein the front housing portion has two sidewalls, a front inclined plane between the two sidewalls and a rear inclined plane connecting to and subtending at an angle to the front incline plane which co-operatively form a V-type cavity.

8. The portable electronic device as claimed in claim 7, wherein the cavity has an opening communicating with an external environment and closed by the cover.

9. The portable electronic device as claimed in claim 7, wherein the liquid crystal module is received in the cavity.

10. The portable electronic device as claimed in claim 7, wherein the front reflecting layer is disposed on the front inclined plane, and the rear reflecting layer is disposed on the rear inclined plane.

11. The portable electronic device as claimed in claim 1 further comprising a light detector included therein for detecting intensity of external light in electronic communication with a micro-programmed controller unit of the portable electronic device, the micro-programmed controller unit being configured for controlling light emission of an internal back light to provide a substantial back light source based on external light intensity information transmitted by the light detector to the micro-programmed controller unit.

12. A portable electronic device, comprising:
a display assembly, the display assembly including an internal back light source, and a power saving unit including a cover and a reflector, the cover concentrating external light to the reflector, the reflector directing the external light to the display assembly;
wherein the portable electronic device is switchable between a power saving mode to use external light as back light source and a normal mode to use the internal back light source.

13. The portable electronic device as claimed in claim 12, wherein the internal back light source is emitted from light emitting diodes included in the main body.

14. The portable electronic device as claimed in claim 12, wherein the reflector comprises a front reflecting layer configured for receiving external light transmitted from the cover and reflecting the light, and a rear reflecting layer configured for receiving, reflecting and scattering the received light to the liquid crystal module.

15. A display apparatus comprising:
a display assembly including a liquid crystal panel and an internal electrical light unit, the internal electrical light unit acting as a first backlight module for the liquid crystal panel when the display apparatus works at a first state;
an external light unit being configured for directing outside light toward the liquid crystal panel, the external light unit acting as a second backlight module for the liquid crystal panel using the outside light when the display apparatus works at a second state; and
a switch unit connected to the display assembly and operable to switch the display apparatus between the first and second states.

16. The display apparatus of claim 15, wherein the external light unit includes at least a reflector configured for reflecting the outside light toward the liquid crystal panel.

17. The display apparatus of claim 16, wherein the external light unit includes a light concentration element configured for concentrating and directing the outside light toward the reflector.

18. The display apparatus of claim 17, wherein the light concentration element covers the liquid crystal panel to protect the liquid crystal panel.
